(19) United States
(12) Patent Application Publication
(10) Pub. No.: US 2007/0002180 A1
(43) Pub. Date: Jan. 4, 2007

(54) Strength parameter-based color conversion of digital images

(75) Inventor: Khageshwar Thakur, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/170,814

(22) Filed: Jun. 30, 2005

(51) Int. Cl. H04N 9/66

(52) U.S. Cl. 348/638

(57) ABSTRACT

A digital image process manipulates colors of some or all pixels of an original image to appear faded or antique. The pixels may be represented by a luminance-chrominance color model. A target color is represented by target chrominance values. A strength parameter is used in conversion between the initial chrominance values and the target values. The chrominance values of pixels may be shifted from the initial values towards the target values by an amount that is in proportion to the strength parameter. The strength parameter may be a selectable, predetermined parameter that is applicable to each converted pixel. Alternatively, the strength parameter may be a calculated parameter that varies for each pixel and may be based upon the difference between the initial chrominance values and reference chrominance values. The reference values may be the chrominance values of a selected region of the digital image.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC

None.

### BACKGROUND

1. Field of the Invention

The present invention relates generally to digital image processing. More specifically, the present invention relates to antiquing a digital image to produce an artificially aged or faded duplicate of the original.

2. Description of Related Art

An inherent advantage of representing images digitally is the ability to numerically manipulate the images to produce altered duplicates of the original. Digital filtering, brightening, and color modification are a few examples of the types of digital processing that may be used to alter an original digital image. While it is generally understood that digital alterations may be applied in a uniform manner to an entire image, it is sometimes desirable to provide additional control over the method in which the modification is applied.

One image processing technique contemplates artificially aging an image, making the image appear years or decades old. Antique images typically have a dull and yellowish appearance. In certain cases, antiquing an entire image may be performed by replacing existing colors with these dull and yellowish colors. However, blanket replacement of colors with a single color or even a range of colors may not be an optimal or desirable solution for antiquing images. In certain instances, it may be desirable to maintain some of the original color or luminosity over all or some of the original image.

### SUMMARY

The present invention is directed to devices and methods of selectively processing a digital image to appear old or faded. The process may be applied to an entire image or to select areas of the image. The process may be applied to a digital image whose pixels are represented by a luminance-chrominance color model. In one embodiment, the images are converted by shifting the chrominance values for pixels of the digital image toward target chrominance values. The target chrominance values may reflect a dull, yellow color representative of antique images. The target chrominance values may reflect a faded gray color. Other colors may also be used for the target chrominance values.

The amount of shift from the current chrominance values toward the target chrominance values may be proportional to a strength parameter. Various embodiments of a strength parameter may be used. According to one embodiment, the strength parameter may be a predetermined parameter that is applicable to each pixel of the digital image that undergoes the conversion. The strength parameter may be a user-adjustable parameter. Alternatively, the strength parameter may be a calculated parameter that varies for each pixel of the digital image. In the latter case, the strength parameter for each pixel to be converted may be calculated based upon a comparison of the current chrominance values to a set of reference chrominance values.

In one embodiment, the reference chrominance values are the chrominance values of a selected region of the digital image. In other words, the strength parameter for a pixel varies according to the color distance from a selected color. In another embodiment, the reference chrominance values are the target chrominance values. In another embodiment, the reference chrominance values are color-neutral so that the strength parameter of a pixel defines the colorfulness of that pixel.

The digital image processing may be implemented in a multifunction machine having, for example, printing, scanning and copying functions. As such, the processing may be performed entirely within the multifunction device. Alternatively, the processing may be performed in part, or in whole, on a host computer where the converted image may be stored or subsequently printed using an image forming device such as a multifunction device.

### BRIEF DESCRIPTION OF THE DRAWINGS

FIG. 1 is a perspective view of one embodiment of a computing system in which the present invention may be implemented;

FIG. 2 is a functional block diagram of one embodiment of a computing system in which the present invention may be implemented;

FIG. 3 is a diagram of exemplary computer processing logic to implement image processing according to one embodiment of the present invention; and

FIG. 4 is a diagram of exemplary computer processing logic to calculate a strength parameter used in image processing according to one embodiment of the present invention.

### DETAILED DESCRIPTION

The present invention is directed to embodiments of devices and methods for digitally processing some or all pixels of an original image to appear faded or antique. The process may be applied to some or all pixels of an image and works by shifting the color intensity of pixels of the digital image toward target values. The techniques are flexible in that the target values may represent a dull, yellow color representative of antique images, a faded gray color, or other selectable colors. The amount of color conversion may be controlled by a strength parameter that is predetermined or calculated based on image properties.

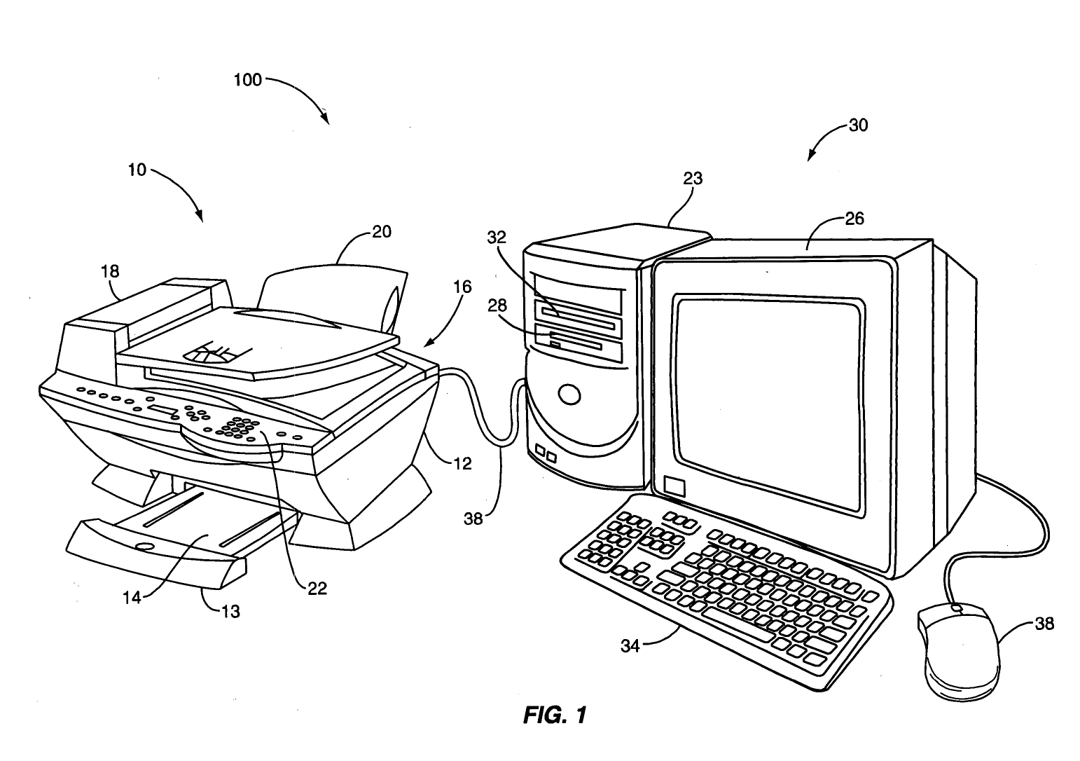

The processing techniques disclosed herein may be implemented in a variety of computer processing systems. For instance, the disclosed image processing technique may be executed by a computing system 100 such as that generally illustrated in FIG. 1. The exemplary computing system 100 provided in FIG. 1 depicts one embodiment of a representative multifunction device, such as an All-In-One (AIO) device, indicated generally by the numeral 10 and a computer, indicated generally by the numeral 30. A desktop computer 30 is shown, but other conventional computers, including laptop and handheld computers are also contemplated. In the embodiment shown, the multifunction device 10 comprises a main body 12, at least one media tray 13 holding a stack of print media 14, a flatbed (or feed-through as known in the art) scanner 16 comprising a document handler 18, a media output tray 20, and a user interface panel 22. The multifunction device 10 is adapted to perform multiple home or business office functions such as printing, faxing, scanning, and copying. Consequently, the multifunction device 10 includes further internal components not visible in the exterior view shown in FIG. 1. The multifunction device may also include a memory card reader for reading various formats of memory cards used in digital cameras or video recorders and may include a port for the direct connection of a digital camera or digital video recorder.

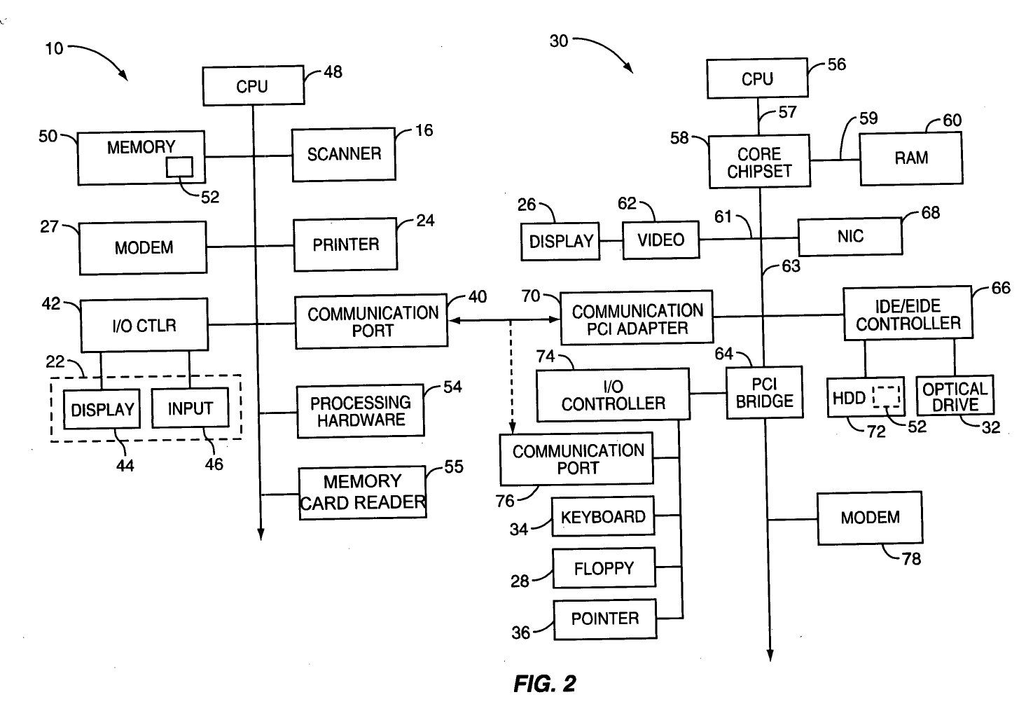

The exemplary computing system 100 shown in FIG. 1 also includes an associated computer 30, which may include a CPU tower 23 having associated internal processors, memory, and circuitry (not shown in FIG. 1, but see FIG. 2) and one or more external media drives. For example, the CPU tower 23 may have a floppy disk drive (FDD) 28 or other magnetic drives and one or more optical drives 32 capable of accessing and writing computer readable or executable data on discs such as CDs or DVDs. The exemplary computer 30 further includes user interface components such as a display 26, a keyboard 34, and a pointing device 36 such as a mouse, trackball, light pen, or, in the case of laptop computers, a touchpad or pointing stick.

An interface cable 38 is also shown in the exemplary computing system 100 of FIG. 1. The interface cable 38 permits one- or two-way communication between the computer 30 and the multifunction device 10. When coupled in this manner, the computer 30 may be referred to as a host computer for the multifunction device 10. Certain operating characteristics of the multifunction device 10 may be controlled by the computer 30 via printer or scanner drivers stored on the computer 30. For instance, print jobs originated on the computer 30 may be printed by the multifunction device 10 in accordance with resolution and color settings that may be set on the computer 30. Where a two-way communication link is established between the computer 30 and the multifunction device 10, information such as scanned images or incoming fax images may be transmitted from the multifunction device 10 to the computer 30.

With regards to the processing techniques disclosed herein, certain embodiments may permit operator control over image processing to the extent that a user may select certain image areas or colors that are used in the image conversion. Accordingly, the user interface components such as the user interface panel 22 of the multifunction device 10 and the display 26, keyboard 34, and pointing device 36 of the computer 30 may be used to control various processing parameters. As such, the relationship between these user interface devices and the processing components is more clearly shown in the functional block diagram provided in FIG. 2.

FIG. 2 provides a simplified representation of some of the various functional components of the exemplary multifunction device 10 and computer 30. For instance, the multifunction device 10 includes the previously mentioned scanner 16 as well as an integrated printer 24, which may itself include a conventionally known ink jet or laser printer with a suitable document transport mechanism. Interaction at the user interface 22 is controlled with the aid of an I/O controller 42. Thus, the I/O controller 42 generates user-readable graphics at a display 44 and interprets commands entered at a keypad 46 or via the display 44. The display 44 may be embodied as an alphanumeric LCD display and keypad 46 may be an alphanumeric keypad. Alternatively, the display and input functions may be accomplished with a composite touch screen (not shown) that simultaneously displays relevant information, including images, while accepting user input commands by finger touch or with the use of a stylus pen (not shown).

The exemplary embodiment of the multifunction device 10 also includes a modem 27, which may be a fax modem compliant with commonly used ITU and CCITT compression and communication standards such as the V.XX and Class 1-4 standards known by those skilled in the art. The multifunction device 10 may also be coupled to the computer 30 with an interface cable 38 coupled through a compatible communication port 40, which may comprise a standard parallel printer port or a serial data interface such as USB 1.1, USB 2.0, IEEE-1394 (including, but not limited to 1394a and 1394b) and the like.

The multifunction device 10 may also include integrated wired or wireless network interfaces. Therefore, communication port 40 may also represent a network interface, which permits operation of the multifunction device 10 as a stand-alone device not expressly requiring a host computer 30 to perform many of the included functions. A wired communication port 40 may comprise a conventionally known RJ-45 connector for connection to a 10/100 LAN or a 1/10 Gigabit Ethernet network. A wireless communication port 40 may comprise an adapter capable of wireless communications with other devices in a peer mode or with a wireless network in an infrastructure mode. Accordingly, the wireless communication port 40 may comprise an adapter conforming to wireless communication standards such as Bluetooth®, 802.11x, 802.15 or other standards known to those skilled in the art.

The multifunction device 10 may also include one or more processing circuits 48, system memory 50, which generically encompasses RAM and/or ROM for system operation and code storage as represented by numeral 52. The system memory 50 may suitably comprise a variety of devices known to those skilled in the art such as SDRAM, DDRAM, EEPROM, Flash Memory, and perhaps a fixed hard drive. Those skilled in the art will appreciate and comprehend the advantages and disadvantages of the various memory types for a given application.

Additionally, the multifunction device 10 may include dedicated image processing hardware 54, which may be a separate hardware circuit, or may be included as part of other processing hardware. For example, image processing may be implemented via stored program instructions for execution by one or more Digital Signal Processors (DSPs), ASICs or other digital processing circuits included in the processing hardware 54. Alternatively, stored program code 52 may be stored in memory 50, with the image processing techniques described herein executed by some combination of processor 48 and processing hardware 54, which may include programmed logic devices such as PLDs and FPGAs. In general, those skilled in the art will comprehend the various combinations of software, firmware, and hardware that may be used to implement the various embodiments described herein.

FIG. 2 also shows functional components of the exemplary computer 30, which comprises a central processing unit (“CPU”) 56, core logic chipset 58, system random access memory (“RAM”) 60, a video graphics controller 62 coupled to the aforementioned video display 26, a PCI bus bridge 64, and an IDE/EIDE controller 66. Single or multilevel cache memory (not illustrated) may also be included in the computer 30 according to the current art of microprocessor systems. The single CPU block 56 may be implemented as a plurality of CPUs 56 in a symmetric or asymmetric multi-processor configuration.

In the exemplary computer 30 shown, the CPU 56 is connected to the core logic chipset 58 through a host bus 57. The system RAM 60 is connected to the core logic chipset 58 through a memory bus 59. The video graphics controller 62 is connected to the core logic chipset 58 through an AGP bus 61 or the primary PCI bus 63. The PCI bridge 64 and IDE/EIDE controller 66 are connected to the core logic chipset 58 through the primary PCI bus 63. A hard disk drive 72 and the optical drive 32 discussed above are coupled to the IDE/EIDE controller 66. Also connected to the PCI bus 63 are a network interface card (“NIC”) 68, such as an Ethernet card, and a PCI adapter 70 used for communication with the multifunction device 10 or other peripheral device. Thus, PCI adapter 70 may be a complementary adapter conforming to the same or similar protocol as communication port 40 on the multifunction device 10. As indicated above, PCI adapter 70 may be implemented as a USB or IEEE 1394 adapter. The PCI adapter 70 and the NIC 68 may plug into PCI connectors on the computer 30 motherboard (not illustrated). The PCI bridge 64 connects over an EISA/ISA bus or other legacy bus 65 to a fax/data modem 78 and an input-output controller 74, which interfaces with the aforementioned keyboard 34, pointing device 36, floppy disk drive (“FDD”) 28, and optionally a communication port such as a parallel printer port 76. As discussed above, a one-way communication link may be established between the computer 30 and the multifunction device 10 or other printing device through a cable interface indicated by dashed lines in FIG. 2.

Relevant to the digital image processing techniques disclosed herein, digital images may be read from a number of sources in the computing system 100 shown. For example, hard copy images may be scanned by scanner 16 to produce a digital reproduction or obtained from a memory card reader 55 or directly from a digital camera or video recorder through a digital image port (not shown). Alternatively, the digital images may be stored on fixed or portable media and accessible from the HDD 72, optical drive 32, floppy drive 28, or accessed from a network by NIC 68 or modem 78. Further, as mentioned above, the various embodiments of the digital image processing techniques may be implemented as a device driver, program code 52, or software that is stored in memory 50, on HDD 72, on optical discs readable by optical disc drive 32, on floppy disks readable by floppy drive 28, or from a network accessible by NIC 68 or modem 78. Those skilled in the art of computers and network architectures will comprehend additional structures and methods of implementing the techniques disclosed herein.

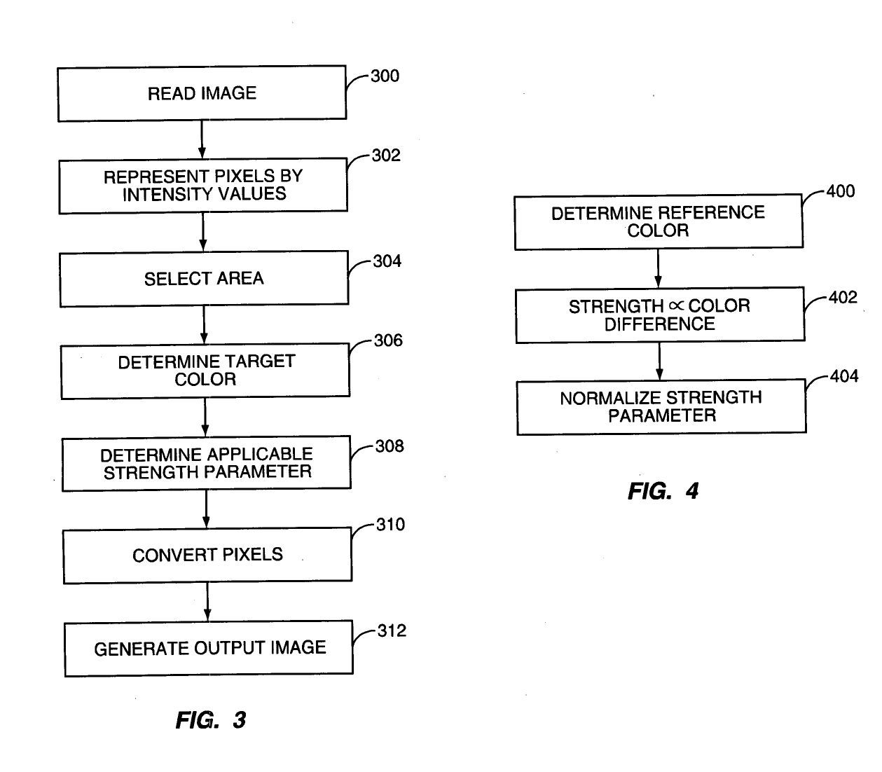

FIG. 3 shows the general procedure executed by the computing system 100 in performing the digital processing techniques. Embodiments of the digital image processing techniques disclosed herein are directed to the digital alteration of an image to produce artificially aged digital and hardcopy reproductions of an original. The original may be a hard or soft copy image. The process begins at step 300 by reading the image using an appropriate method, including those mentioned above.

The image processing techniques are described below in terms of three main embodiments, each of which performs an alteration to the color components for some or all pixels in the image. It is generally understood that each pixel of an image may be represented using different color models. For the embodiments herein, a luminance-chrominance model is one appropriate model. As such, the embodiments will be described using a Y-Cb-Cr color model, thought it should be understood that other luminance-chrominance models such as LAB, LUV, YIQ, and YUV may be equally applicable. Thus, once the original image is read in step 300, the image is converted, if necessary, into the appropriate color model to represent each pixel as a group of intensity values (step 302). Note, images stored using the JPEG standard (*.jpg extension) are represented using a luminance-chrominance model and may not need to be converted in step 302 after the image is read in step 300.

In the Y-Cb-Cr colorspace model, each of the three color components may be represented as an eight-bit quantity with values ranging from 0 to 255. The Y component corresponds to the perceived brightness of the pixel, which is independent of the color or hue of the pixel. Color information is represented by the two remaining chrominance quantities, Cb and Cr. For this model, a pixel is said to be color-neutral when Cb and Cr have values that are at or near the mid-point of the allowable range. Thus, for an 8-bit quantity, Cb and Cr are each color-neutral at a value of about 128. By comparison, bold colors (e.g., red, blue) are represented by values that are at or near the high and low extremes of the allowable range.

For the incoming image, all or some of the pixels in the image may be converted using the various embodiments of the digital image processing techniques disclosed herein. In step 304, the area to be converted is selected using available user interface devices, including those mentioned above. For example, a region of the image may be selected at the user interface panel 22 directly on the multifunction device 10 or through a combination of interaction with the display 26, keyboard 34, and pointing device 36 on the computer 30. This “Select Area” step 304 may simply assume that the entire image is converted in the absence of the designation of a portion of the current image. In such a case, this step 304 may not require any user interaction.

The various embodiments use a target color for the conversion process. Generally, pixels that are converted using the embodiments herein are shifted towards the target color by an amount that is at least partly determined by a strength parameter. Thus, in steps 306 and 308, the target color and strength parameter are determined. The target color may be quantitatively represented as numerical chrominance values or, alternatively, using preset color names. Example target colors may include gray, sepia, and antique. For the antique color, the image processing techniques operate using previously determined knowledge that antique images have a dull and yellowish appearance. In one embodiment, representative chrominance components for antique images fall in the range between about 90<Cb<110 and 145<Cr<165. In one embodiment, representative chrominance components for antique images fall in the range between about 95<Cb<100 and 150<Cr<155. In one embodiment, the chrominance components for antique images are approximately Cb=98 and Cr=153. Further, as mentioned above, a gray target color may be represented by Cb and Cr values of about 128 each.

The different embodiments of the image processing techniques shift the chrominance values for individual pixels of the image towards the target values using a strength parameter that is determined using different techniques. Each of the three embodiments described below reveal a different approach for determining an applicable strength parameter (step 308). This strength parameter determines the degree of change from the original pixel chrominance values towards the target chrominance values. In one embodiment, the degree of color shift (conversion from the original color towards the target color) is determined by the strength parameter according to the following equations:
OutCb=InCb×strength+TargetCb×(1−strength) (1)
OutCr=InCr×strength+TargetCr×(1−strength) (2)

where:
InCb=Cb component value for the original image,
InCr=Cr component value for the original image,
OutCb=Cb component value for the converted image,
OutCr=Cr component value for the converted image,
TargetCb=Cb component value for the target color,
TargetCr=Cr component value for the target color, and
strength=the strength parameter, which ranges between 0 and 1.

Thus, in the present embodiment, the chrominance values Cb and Cr are weighted between the original input value and the target value. A high strength (strength→1) preserves the original chrominance values while a low strength (strength→0) shifts the chrominance value towards the target value. In one embodiment, the luminance value Y is maintained. In equation form,
OutY=InY (3)

where:
InY=Y component value for the original image, and
OutY=Y component value for the converted image.

In a luminance-chrominance model, the chroma components contain color information that is independent of luminance. In fact, in the Y-Cb-Cr model, the Cb and Cr components are sometimes called color difference components because they are computed as a blue color difference (B-Y) and red color difference (R-Y), respectively, with luminance information subtracted out of the chroma values. Thus, a color shift in a luminance-chrominance model may be executed independent of the luminance component. If other color models are used, a color shift may affect perceived luminance of the image. Thus, the color conversion may also be accompanied by a luminance or brightness conversion.

Once the relevant information needed for the image processing is available, the computing system 100 converts (Step 310) the desired pixels using exemplary equations (1), (2), and (3) and generates an output image (step 312). The output image may be displayed on user interface panel 22, display 26, or printed at the multifunction device 10. The output image may also be stored using an appropriate storage device, such as those described above. The embodiments described below reveal different approaches for determining an applicable strength parameter used in generating the output image.

### EMBODIMENT 1

In a first embodiment, the strength value is predetermined and fixed. The strength value may be user-selectable, either as a numerical value ranging from 0 to 1 or based on predetermined qualitative settings such as light, moderate, or heavy. Since the strength value is fixed, each converted pixel is shifted towards the target color by a common degree. This is not to say that the value of Cb and Cr for each pixel are changed by a fixed amount. Instead, each pixel undergoes a shift that is some percentage of the difference between the original values and the target values.

For example, with an exemplary input value of InCb=198 and a target value of TargetCb=98, the difference between the original value and the target value is 100. A color conversion will change the input value by some fraction of this 100-point difference. If a strength of 0.75 is selected, the output value OutCb is determined using equation (1) above and equals 198×(0.75)+98×(1−0.75)=173, which reflects a 25% change in the component value. Note that a relatively high strength value of 0.75 in this particular example yields an output value for Cb (173) that is closer to the original value of Cb (198) than the target value (98).

In the second and third embodiments, described below, the strength parameter is determined according to the processing steps outlined in FIG. 4. Both the second and third embodiments use a reference color for comparison to the color of pixels in the original image. However, the approach used in determining this reference color and the meaning assigned to the strength parameter is generally different between the second and third embodiments.

### EMBODIMENT 2

In a second embodiment, the strength parameter is derived from the color difference or “colorfulness” of the original pixel as compared to this reference. As with the target color values described above, the reference color may be quantitatively represented as numerical chrominance values or, alternatively, using preset color names. Example reference colors may include gray, sepia, and antique. In an embodiment where a gray or colorless reference is used, the reference values for Cb (REFCb) and Cr (REFCr) may be assigned a value of about 128 each. In another embodiment, the reference chrominance components may be assigned values of approximately REFCb=98 and REFCr=153. In one embodiment, the reference chrominance values REFCb, REFCr are the same as the target chrominance values TargetCb, TargetCr described above. With the reference color values determined, a strength parameter for each pixel in the original image may be determined as a function of the color difference between the original chrominance values InCb, InCr and the reference chrominance values REFCb, REFCr. In one embodiment, the strength parameter for each pixel may be determined (step 402) according to the equation:

$$strength = \frac{\sqrt{{( InCb - REFCb )}^{2} + {( InCr - REFCr )}^{2}}}{N} \qquad ( 4 )$$

where N is a normalizing variable and may be used to bound the upper limit of the strength parameter. In equations (1) and (2) above, it is contemplated that the strength parameter is within the range between about 0 and 1. The N variable may be adjusted to normalize (step 404) the strength parameter so that it falls within this range. For example, if the reference chrominance values REFCb, REFCr are selected so that the numerator has an expected maximum of about 128, the normalizing variable N may also be selected to have a value of about 128. As the reference chrominance values REFCb, REFCr change, the normalizing variable N may also change.

If the reference chrominance values REFCb, REFCr are set to about 128 each, equation (4) will yield large strength values for strong colors and small strength values for neutral colors, where InCb and InCr are close to 128. Thus, the more colorful a pixel is, the higher the strength parameter, and the greater the tendency to retain the original color when equations (1) and (2) are applied. It is worth noting that the values of Cb and Cr are not entirely independent of one another, since both values represent a difference from the Y value. It is likely that for any given pixel, the values of InCb and InCr will not be simultaneously high and/or low. Thus, the value for N should be chosen accordingly.

### EMBODIMENT 3

In a third embodiment, the strength value may be derived using a color difference from a selected region of the original image. This particular embodiment contemplates a user interface in which a user specifies which colors are to be preserved. Exemplary interface configurations may include the user interface panel 22 of the multifunction device 10 and the display 26, keyboard 34, and pointing device 36 of the computer 30. For example, a user may click on a particular object in the image, which establishes reference values (step 400 of FIG. 4) for Y (SelectedY), Cb (SelectedCb), and Cr (SelectedCr). These reference values may be based on the color of a single pixel or on weighted or non-weighted averages of pixel colors in the vicinity of a user selection. In one embodiment, these reference values are used in the equation below to determine a strength value (step 402) for each pixel in the image.

$$strength = \frac{\sqrt{\begin{matrix}{( InY - SelectedY )}^{2} + \\ {( InCb - SelectedCb )}^{2} + \\ {( InCr - SelectedCr )}^{2}\end{matrix}}}{N} \qquad ( 5 )$$

where N is once again a normalizing variable and may be used to bound the upper limit of the strength parameter (step 404).

According to equation (5), for pixels that are similar in color and luminance to the selected reference color, the strength parameter becomes small. Strength increases for pixels that are very different in color from the reference pixel. Strength may be calculated, using this equation, for each pixel in the image. However, in contrast with the first and second embodiments, this embodiment seeks to retain colors with a low strength and convert pixels with a high strength. In other words, this embodiment seeks to retain colors that are close to the reference color and convert very different colors. Thus, in one embodiment, the output chrominance values OutCb, OutCr are generated for each converted pixel using the following equations:
OutCb=InCb×(1−strength)+TargetCb×strength (6)
OutCr=InCr×(1−strength)+TargetCr×strength (7)

where all variables are generally the same as described for equations (1) and (2) above. Note that for equations (6) and (7), the weighting strengths are reversed as compared to equations (1) and (2) above to retain more color in pixels that are similar in color to the reference color. As with previously described embodiments, the output value for pixel luminance may be left unmodified as represented by equation (3) above.

The convention assigned to the uncalculated strength parameter of the first embodiment may be modified if desired. In the first embodiment, where equations (1) and (2) are used, strength is defined so that a higher strength tends to retain original color. However, strength may also be defined so that lower strengths tend to retain original color, in which case, equations (6) and (7) would be used in the first embodiment. Either convention is applicable.

The discussion of the Y-Cb-Cr color model to this point has assumed an 8-bit color depth for each component. It should be understood that different color depths may be used. More or fewer bits may be used to represent each component. For example, a 16-bit scheme may be used for each component resulting in over 65K discrete values for each component. Note however, that adjusting the color depth in this manner may require adjustment to various parameters and variables described herein. For instance, the chrominance values for the target color, the reference color, and the normalization variable may all require adjustment based on the chosen color depth.

The present invention may be carried out in other specific ways than those herein set forth without departing from the scope and essential characteristics of the invention. For instance, the pixel conversion equations (1), (2), (6), (7) provided above are expressed as linear equations with the amount of conversion being linearly proportional to the strength parameter. The techniques described herein are not intended to be limited to linear conversion equations as higher order or exponential equations may be applicable as well. Further, whereas the disclosed strength parameter has been described as falling within a range between about zero and one, different ranges are certainly possible. Accordingly, the conversion equations should be adjusted to conform to different values of the strength parameter. The present embodiments are, therefore, to be considered in all respects as illustrative and not restrictive, and all changes coming within the meaning and equivalency range of the appended claims are intended to be embraced therein.

1. A method of selectively antiquing a digital image whose pixels are represented by a luminance-chrominance color model, the method comprising shifting chrominance values for designated pixels of said digital image toward target chrominance values by a percentage of the difference between current chrominance values and the target chrominance values, the percentage based at least partly upon a strength parameter.

2. The method of claim 1 wherein the strength parameter is a predetermined parameter that is applicable to each designated pixel of said digital image that undergoes said shifting.

3. The method of claim 2 wherein the strength parameter is a user-adjustable parameter.

4. The method of claim 1 wherein the strength parameter is a calculated parameter that varies for each pixel of said digital image, the strength parameter determined by a method comprising:
receiving reference chrominance values; and
for each designated pixel to be shifted, calculating the strength parameter based upon the difference between the current chrominance values and the reference chrominance values.

5. The method of claim 4 wherein the reference chrominance values are the chrominance values of a selected region of said digital image.

6. The method of claim 4 wherein the reference chrominance values are the target chrominance values.

7. The method of claim 1 wherein shifting chrominance values for pixels of said digital image comprises shifting chrominance values of pixels within a predetermined area of said digital image.

8. The method of claim 1 wherein the designated pixels comprise substantially all pixels of the digital image.

9. A method of altering a digital image, the method comprising:
determining initial luminance and chrominance component values for pixels of the digital image;
receiving a target color represented by target chrominance values;
determining a strength parameter that is a factor in conversion between the initial chrominance component values and the target chrominance values; and
converting the chrominance values of predetermined pixels of the digital image in accordance with the strength parameter while retaining the initial luminance component values for those predetermined pixels.

10. The method of claim 9 wherein converting the chrominance values of predetermined pixels of the digital image comprises shifting the chrominance values of the predetermined pixels of the digital image from the initial chrominance values towards the target chrominance values by an amount that is in proportion to the strength parameter.

11. The method of claim 9 wherein the strength parameter is a predetermined parameter that is applicable to each predetermined pixel of the digital image that undergoes said converting.

12. The method of claim 12 wherein the strength parameter is a user-adjustable parameter.

13. The method of claim 9 wherein the strength parameter is a calculated parameter that varies for each pixel of the digital image, the strength parameter determined by:
receiving reference chrominance values; and
for each predetermined pixel to be shifted, calculating the strength parameter based upon the difference between the initial chrominance values and the reference chrominance values.

14. The method of claim 13 wherein the reference chrominance values are the chrominance values of a selected region of the digital image.

15. The method of claim 13 wherein the reference chrominance values are the target chrominance values.

16. The method of claim 9 wherein the predetermined pixels comprise substantially all pixels of the digital image.

17. A computer readable medium which stores computer-executable process steps for antiquing a digital image, said computer-executable process steps causing a computer to perform the steps of:
determining input values for luminance and chrominance components of individual pixels of said digital image;
determining a strength parameter;
determining target chrominance component values; and
changing the chrominance values of the individual pixels of said digital image to output values that range between the calculated input chrominance values and the target chrominance values, the amount of change determined at least partially by the strength parameter.

18. The computer readable medium of claim 17 wherein determining a strength parameter comprises receiving a value for the strength parameter from an input.

19. The computer readable medium of claim 18 wherein changing the chrominance values of the individual pixels of said digital image comprises applying substantially the same strength parameter to each of the individual pixels.

20. The computer readable medium of claim 17 wherein determining a strength parameter comprises calculating the strength parameter for the individual pixels of said digital image by receiving reference chrominance values, and for each pixel whose chrominance values are to be changed, calculating the strength parameter based at least partly upon the difference between the input chrominance values for that pixel and the reference chrominance values.

21. The computer readable medium of claim 17 wherein receiving reference chrominance values comprises determining chrominance values for a region of said digital image that is received from a user input.

22. The computer readable medium of claim 17 wherein determining target chrominance component values comprises receiving values for the target chrominance from an input.
